(19) United States
(12) Patent Application Publication
(10) Pub. No.: US 2013/0344407 A1
(43) Pub. Date: Dec. 26, 2013

(54) Hydrogen Generator and Method of Controlling Reaction

(71) Applicant: Alvin R. Mick, Lorain, OH (US)

(72) Inventor: Alvin R. Mick, Lorain, OH (US)

(73) Assignee: EVEREADY BATTERY COMPANY, INC., St. Louis, MO (US)

(21) Appl. No.: 13/532,005

(22) Filed: Jun. 25, 2012

(51) Int. Cl. C01B 3/02; H01M 8/06; B01J 7/02; C01B 3/06; B01J 7/00

(52) U.S. Cl. 429/416; 423/648.1; 423/657; 422/129; 422/162

(57) ABSTRACT

A hydrogen generator is provided for generating hydrogen gas for a fuel cell stack. The hydrogen generator includes a reaction area and a reactant storage area for storing a reactant composition for reacting to generate hydrogen gas. The hydrogen generator also includes a high pH solution contained within a solution storage area. Hydrogen gas is discharged through an outlet that passes through a filter to supply gas to the fuel cell. A predetermined quantity of high pH solution is injected into the reaction area to stop the reaction when electrical power is no longer demanded.

### FIELD OF THE INVENTION

This invention relates to a hydrogen generator, particularly a hydrogen generator for a fuel cell system, and a method of producing hydrogen gas with the hydrogen generator.

### BACKGROUND

Interest in fuel cell batteries as power sources for portable electronic devices has grown. A fuel cell is an electrochemical cell that uses materials from outside the cell as the active materials for the positive and negative electrode. Because a fuel cell does not have to contain all of the active materials used to generate electricity, the fuel cell can be made with a small volume relative to the amount of electrical energy produced compared to other types of batteries.

Fuel cells can be categorized according to the types of materials used in the positive electrode (cathode) and negative electrode (anode) reactions. One category of fuel cell is a hydrogen fuel cell using hydrogen as the negative electrode active material and oxygen as the positive electrode active material. When such a fuel cell is discharged, hydrogen is oxidized at the negative electrode to produce hydrogen ions and electrons. The hydrogen ions pass through an electrically nonconductive, ion permeable separator and the electrons pass through an external circuit to the positive electrode, where oxygen is reduced.

In some types of hydrogen fuel cells, hydrogen is formed from a fuel supplied to the positive electrode side of the fuel cell, and hydrogen is produced from the supplied fuel. In other types of hydrogen fuel cells, hydrogen gas is supplied to the fuel cell from a source outside the fuel cell. A fuel cell system can include a fuel cell battery, including one or more fuel cells, and a hydrogen source, such as a hydrogen tank or a hydrogen generator. In some fuel cell systems, the hydrogen source can be replaced after the hydrogen is depleted. Replaceable hydrogen sources can be rechargeable or disposable.

A hydrogen generator uses one or more reactants containing hydrogen that can react to produce hydrogen gas. The reaction can be initiated in various ways, such as hydrolysis and thermolysis. For example, two reactants can produce hydrogen and byproducts when mixed together. A catalyst can be used to catalyze the reaction. When the reactants react, reaction products including hydrogen gas and byproducts are produced.

In order to minimize the volume of the hydrogen generator, volume that is initially occupied by the reactants can be used to accommodate reaction products as the reactants are consumed by arranging the components of the hydrogen generator in a volume exchanging configuration. As reactants are consumed, volume that they had occupied is simultaneously made available to contain reaction products.

The hydrogen gas is separated from byproducts and unreacted reactants, and the gas exits the hydrogen generator and is provided to the fuel cell battery. Various means for separating the hydrogen gas are known, including porous filters to separate solids from the hydrogen gas and gas permeable, liquid impermeable membranes to separate the hydrogen gas from liquids.

It is desirable to control the reaction of the hydrogen generators to prevent excessive generation of hydrogen and excessive pressure. It is also desirable to provide for a hydrogen generator that may be manufactured with a simple design and at a low cost.

### SUMMARY

The above advantages are provided by a hydrogen generator and method of producing hydrogen gas using a hydrogen generator according to the present invention.

According to a first aspect of the present invention is a method of producing hydrogen gas using a hydrogen generator which includes a container and a reaction area within the container. The method includes moving a fluid including a first reactant from a reactant storage area to the reaction area to react the reactant in the reaction area to produce hydrogen gas. The method also includes injecting a quantity of high pH solution into the reaction area to stop the reaction when hydrogen gas is not demanded.

Embodiments of the first aspect of the invention can include one or more of the following features:

the method includes detecting electrical power demand, wherein the high pH solution is injected into the reaction area when electrical power is no longer demanded;

the high pH solution has a pH value in the range of 12-14;

the high pH solution includes water and sodium hydroxide;

the high pH solution includes water and potassium hydroxide;

the high pH solution includes about 85 weight percent water;

the high pH solution is contained within a solution storage area within the container;

the method includes using a pump to pump the high pH solution from the solution storage area through a fluid passage into the reaction area;

the pump is located outside of the compartment, such that the high pH solution is pumped from the solution storage area, to the pump outside the container and back into the container to the fluid passage;

the pump further pumps the reactant from the reactant storage area, to the pump outside of the container and back into the fluid passage;

the reactant in the fluid is a first reactant and includes water, and a second reactant including sodium borohydride (SBH) is provided;

the first reactant further includes an acid;

the second reactant further includes an acid; and

the reactant storage area is within the container.

A second aspect of the present invention is a hydrogen generator including a container, a reaction area within the container, a fluid including a reactant, and a high pH solution. The fluid including the reactant moves to the reaction area to react to produce hydrogen gas. The high pH solution is injected into the reaction area to stop the reaction when hydrogen is no longer demanded.

Embodiments of the second aspect of the invention can include one or more of the following features:
the high pH solution is contained within a solution storage area in the container;
the fluid is contained with a reactant storage area in the container;
the hydrogen generator includes a pump for pumping the fluid into the reaction area and pumping the high pH solution into the reaction area;
the pump is located outside of the container;
the hydrogen generator includes a valve controlled to selectively pump one of the fluid and the high pH solution to the reaction area;
the fluid includes water as a first reactant, and a second reactant including sodium borohydride (SBH) is disposed in the reaction area;
the second reactant further includes an acid;
the fluid includes an acid;
the hydrogen generator includes a filter disposed between the hydrogen outlet and the reaction area;
the high pH solution has a pH value in the range of 12-14;
the high pH solution includes water and sodium hydroxide;
the high pH solution includes water and potassium hydroxide; and
the high pH solution includes about 85 weight percent water.

A further aspect of the present invention is a fuel cell system including one or more fuel cells and a hydrogen generator including a container, a first reactant, an optional second reactant and a reaction area. The fuel cell system also includes a reactant storage area containing a fluid including the first reactant and a solution storage area containing a high pH solution. The fuel cell system further includes a controller for controlling the injection of the fluid into the reaction area and the injection of the high pH solution, wherein a quantity of high pH solution is injected into the reaction area to stop the reaction.

These and other features, advantages and objects of the present invention will be further understood and appreciated by those skilled in the art by reference to the following specification, claims and appended drawings.

Unless otherwise specified, the following definitions and methods are used herein:
“effluent” means non-gaseous reaction products and unreacted reactants, solvents and additives;
“expand” when used in describing a filter means for the filter material to simultaneously increase in volume, increase in porosity and decrease in density and pertains only to the material of which the filter is made;
“initial” means the condition of a hydrogen generator in an unused or fresh (e.g., refilled) state, before initiating a reaction to generate hydrogen;
“high pH solution” means a liquid with a pH above 7.0, preferably 12.0 or greater;
“volume exchanging relationship” means a relationship between two or more areas or containers within a hydrogen generator such that a quantity of volume lost by one or more of the areas or containers is simultaneously gained by one or more of the other areas or containers; the volume thus exchanged is not necessarily the same physical space, so volume lost in one place can be gained in another place.

Unless otherwise specified herein, all disclosed characteristics and ranges are as determined at room temperature (20-25° C.).

### BRIEF DESCRIPTION OF THE DRAWINGS

In the drawings:

FIG. 1 is a schematic diagram of a fuel cell system including a hydrogen generator having a high pH solution for controlling the reaction, according to one embodiment;

FIG. 2 is a cross-sectional view of the hydrogen generator containing the high pH solution, according to one embodiment;

FIG. 3 is a block diagram illustrating a control system for controlling the hydrogen generator; and

FIG. 4 is a flow diagram illustrating a routine for controlling the reaction in the hydrogen generator.

### DETAILED DESCRIPTION

The present invention includes a separate hydrogen gas generator that can be incorporated into a fuel cell system including a fuel cell battery, but it is not part of the fuel cell itself. It is typically a removable, replaceable or refillable unit that can supply hydrogen to a fuel cell, rather than supplying a liquid or other fluid that is reformed by or within the fuel cell to produce hydrogen gas or protons.

The fuel cell with which the hydrogen generator can be used can be a battery containing a single fuel cell, or it can be a battery containing a plurality of fuel cells (sometimes referred to as a fuel cell stack). The fuel cell can be any type of fuel cell that uses hydrogen as a fuel. Examples include proton exchange membrane fuel cells, alkaline fuel cells and solid oxide fuel cells.

In one embodiment, a hydrogen generator includes a container with one or more reactant storage areas, a reaction area, a high pH solution storage area and optionally an effluent storage area within the container. One or more reactant-containing fluids, each containing one or more reactants, are transferred from the reactant storage area or areas to the reaction area, where the reactant or reactants react to produce hydrogen gas and byproducts. One or more reactants can also be initially contained within the reaction area. The reaction can be catalyzed by a catalyst, which can be initially in the reaction area or contained in a fluid transferred to the reaction area. The byproducts can include gaseous, liquid and solid reaction products. The production of hydrogen gas can force effluent from the reaction area, through an effluent passage, to the effluent storage area. The effluent can include reaction byproducts as well as unreacted reactants and additives. A predetermined quantity of high pH solution is transferred from the high pH solution storage area to the reaction area to stop the reaction when hydrogen demand ceases.

The reactant-containing fluid can be a liquid or other easily transported fluid. The reactant can be the fluid (e.g., water), or the reactant can be mixed, suspended, dissolved or otherwise contained in a liquid. After the fluid is transported from the reactant storage area to the reaction area, it reacts to produce hydrogen gas. In one embodiment, the reactant or reactants react upon contact with a catalyst in the reaction area. In another embodiment, two fluids, one or both including a reactant, are transported to the reaction area. The fluids may come in contact with each other in an intermediate mixing area or within the reaction area, where they react to produce hydrogen gas; the reaction may be catalyzed by a catalyst, which can be initially contained in the reaction area or in a fluid transported to the reaction area. In yet another embodiment, one reactant is contained in the reaction area, preferably in a solid form, and another reactant is transported from the reactant storage area to the reaction area, where the reactants react to produce hydrogen gas; the reaction may be catalyzed by a catalyst in the reaction area.

The reactant storage, reaction, solution storage and effluent storage areas are preferably arranged in a volume exchanging configuration such that, as reactants are consumed during operation of the hydrogen generator, the effluent storage area simultaneously increases in volume by moving into space made available by a reduction in volume of the areas initially containing reactant and high pH solution to accommodate the effluent within the effluent storage area. In this way the total volume of the hydrogen generator can be minimized, since the amount of initial void volume within the hydrogen generator can be kept at a minimum (though some initial void volume may be necessary, if the solid and liquid reaction products have a greater volume than the initial total volume of the reactants for example). Any suitable volume exchanging configuration can be used. For example, one or more areas containing reactant (e.g., a reactant storage area and/or a reaction area containing a reactant) can be adjacent to the effluent storage area, or the effluent storage area can be separated from the areas containing reactant by one or more other components of the hydrogen generator that can move or otherwise allow the volume exchange.

Hydrogen gas is separated from the liquid and solid effluent and is released through a hydrogen outlet to an apparatus such as a fuel cell as needed. A filter and a hydrogen permeable, liquid impermeable component can be used to separate the hydrogen. The filter removes solids and may remove liquids as well, and the hydrogen permeable, liquid impermeable component removes liquids and any remaining solids, allowing only gas to pass through the hydrogen outlet. Optionally, other components may be included within or downstream from the hydrogen generator to remove other gases and impurities from the hydrogen flow.

The filter may initially be compressed within the effluent storage area to reduce its initial volume and porosity. As the hydrogen generator is operated and the effluent storage area increases in volume, the filter expands. This has several advantages. First, the filter is initially smaller in size, allowing the effluent storage area to be smaller initially, thereby contributing to the volumetric efficiency of the hydrogen generator. Second, the filter can better conform to the size of the effluent storage area and reduce the flow of effluent around the filter as the effluent storage area becomes larger. Third, as the filter becomes more porous it may be better able to continue to remove particulate material without becoming clogged. Fourth, the filter can provide a force (in addition to any force applied by the hydrogen gas, the effluent and any other component, such as a biasing component) to facilitate the increase in volume of the effluent storage area.

In various embodiments, as space becomes available as a result of the volume exchange, the filter can expand due to its elasticity, by being pulled by another internal component of the hydrogen generator to which the filter is attached, by a biasing member within or surrounded by the filter, by some other means, or a combination thereof. For example, an elastic material can expand due to a reduction in compressive stress. In another example, one portion of the filter is attached to an internal surface of the housing, and another portion of the filter is attached to a moveable partition. The moveable partition can pull the attached portion of the filter (e.g., away from the housing surface to which the filter is also attached), expanding the filter. A moveable partition can be moved by a biasing member such as a spring or by a pressure differential on opposite sides of the partition, for example. In yet another example, one or more springs can be disposed within the filter so the filter is forced to expand by the springs.

The filter can be a single component filter. It can have a uniform composition and porosity before compression, or the composition and porosity can vary. In one embodiment the filter before compression is more porous in an upstream portion (the portion that will be closer to the effluent passage) and less porous in a downstream portion (the portion that will be closer to the hydrogen outlet). In this way the filter can remove larger particles in the upstream portion while allowing smaller particles to pass to the downstream portion, to help prevent clogging of the filter.

The filter can be a multi-component filter, at least one component of which is initially compressed and expands during operation of the hydrogen generator. Two or more components can have different porosities before compression. It can be advantageous for a higher porosity filter component to be located at the upstream side of the filter and a lower porosity filter component to be located at the downstream side of the filter. If there are more than two filter components, they can be arranged according to porosity, with the more porous filter components being upstream from the less porous filter components. The individual filter components can be of uniform or non-uniform composition and porosity. All filter components can be made of the same type of material, or different materials can be used for individual filter components. Two or more filter components can be joined together to create a laminar filter having different layers. Filter components can be joined by any suitable method, such as by bonding with an adhesive.

The filter material and the amount of initial compression can be selected, based at least in part on the expected amount and composition of the effluent, to provide at least a minimum filter porosity at all times as the filter expands and retains a portion of the effluent during use of the hydrogen generator, such that sufficient hydrogen gas can reach the hydrogen permeable, liquid impermeable component and the outlet to provide at least a minimum desired hydrogen flow rate.

Desirable properties of the filter components and the materials from which they are made include: chemical stability in contact with the effluent during at least the expected duration of use, compressibility, the ability to expand or be expanded to the desired extent after being compressed before and during use, and porosity and pore size distribution within the desired ranges before and during use. Affinity or lack of affinity for liquid in the effluent can also be considered in material selection.

In one embodiment, at least a portion of the filter is made from a material that does not have an affinity for, and may even tend to repel liquid in the effluent. For example, where the effluent contains an aqueous liquid, a portion of the filter may be a material that is not hydrophilic and may be hydrophobic. If only a portion of the filter does not have an affinity for or tends to repel liquid in the effluent, preferably at least that portion of the filter is proximal to the effluent entryway to the effluent storage area. In this way the portion of the filter proximal to the effluent entryway can remove solids from the hydrogen gas flow, and as the filter expands the filter can accommodate an increasing amount of solids. In this embodiment, it may be possible to avoid premature blocking of the pores in that portion of the filter due to swelling that may accompany absorption of liquid.

In another embodiment, at least a portion of the filter is made from a material that has an affinity for liquid in the effluent. For example, where the effluent contains an aqueous liquid, a portion of the filter may be hydrophilic. If only a portion of the filter has an affinity for liquid in the effluent, preferably at least that portion of the filter is proximal to the liquid-impermeable, gas-permeable component and/or the hydrogen outlet has an affinity for liquid in the effluent. In this way the portion of the filter can absorb liquid that may have solids dissolved therein and prevent blockage of the liquid-impermeable, gas-permeable component and/or the hydrogen outlet.

In yet another embodiment, the filter has both a portion that does not have an affinity for, and may even tend to repel liquid in the effluent, and another portion that has an affinity for liquid in the effluent. The portion that does not have an affinity for liquid in the effluent is proximal the effluent entryway to the effluent storage area, and the portion that has an affinity for liquid in the effluent is proximal one or both of the liquid-impermeable, gas-permeable component and/or the hydrogen outlet.

The hydrogen permeable, liquid impermeable component can be located within the effluent storage area, within the hydrogen outlet, or at an interface between the outlet and either or both of the effluent storage area and a hydrogen passage from the outlet to the fuel cell. In some embodiments it is highly permeable to hydrogen and less permeable to other gases that may be present with the hydrogen, as byproducts or contaminants for example. The hydrogen permeable, liquid impermeable material can be any suitable form, such as a sheet, a membrane or a non-planar form.

Filter components, the hydrogen permeable, liquid impermeable material or both can be coated or partially filled with one or more other materials such as a catalyst to facilitate reaction of unreacted reactants contained in the effluent, an ion-exchange resin to capture detrimental impurities in the effluent, a defoamer to break up gas bubbles in the effluent, and a surfactant to improve the flowability of the effluent.

Any or all of the reactant storage area(s), the reaction area, the solution storage area and the effluent storage area can be defined by one or more of the internal surfaces of the container and other components of the hydrogen generator, or one or more of these areas can be enclosed by an enclosure, such as a reactant storage enclosure, a reaction area enclosure or an effluent storage area enclosure. Such enclosures are able to undergo a change in shape (e.g., by being flexible) so their internal volume can decrease or increase as material exits or enters the enclosure. An enclosure can include a structure such as a bag, a balloon or a bellows, for example. The walls of an enclosure can be pleated or made from an elastomeric material that can stretch or contract, for example, to enable a change in internal volume. In one embodiment, an enclosure can have a wall or a portion of a wall that can stretch to provide a larger internal volume and can apply a force to the contents to facilitate emptying the contents.

In one embodiment, the effluent storage area is enclosed by an enclosure. One or more filter components can be fastened to the enclosure in one or more places to minimize the amount of effluent that can flow around the filter component. The enclosure can be or can include a hydrogen permeable, liquid impermeable material to separate hydrogen gas from liquids in the effluent storage area.

A fluid including a reactant can be transported from the reactant storage area by any suitable means. A fluid including a high pH solution can also be transported from the high pH solution storage area by any suitable means. For example, one or both of the fluid and the high pH solution can be wicked, pumped, expelled by applying a force on the liquids, or a combination thereof. If the fluids are pumped, the pump can be within or outside the hydrogen generator. The pump can be powered by a fuel cell, a battery within the hydrogen generator, or an external power source. A force can be applied directly against a reactant storage area enclosure or a solution storage area enclosure, against a moveable partition in contact with either enclosure, or against one or more other components that make contact with or are a part of the enclosure (such as a valve assembly) for example. Force can be provided in various ways, such as with a spring, an elastic reactant storage enclosure that is initially stretched when full, wrapping the reactant storage enclosure and/or solution storage area enclosure with an elastic member, air or gas pressure on or within the reactant storage enclosure, the expansion of the filter in the effluent storage area, or a combination thereof.

The flow path of the reactant-containing fluid and the high pH solution to and within the reaction area can include one or more fluid passages that can include various components such as tubes, wicks connections, valves, etc. Within the reaction area, the fluid can be dispersed by a dispersing member to improve the distribution of fresh reactant. The fluid and the high pH solution may share a common dispersing member connected to a common fluid path and may employ a valve to control which of the fluid is injected at a given time. According to other embodiments, individual dispersing members may be employed for each of the fluid and the high pH solution. The dispersing member can include one or more structures extending into or within the reaction area. The structures can be tubular or can have other shapes. At least a portion of the dispersing member can be flexible so it can move as the reactant composition and/or the reaction area change shape during operation of the hydrogen generator. In one embodiment the dispersing member can include a tube with holes or slits therein through which the fluid reactant composition can exit. In another embodiment the dispersing member can include a porous material through which the fluid reactant composition can permeate. In another embodiment the dispersing member can include a material through which the fluid or the high pH solution can wick. In yet another embodiment a sleeve of wicking material is provide around another component of the dispersing member. This can keep solid reaction byproducts from forming on the other component and clogging the holes, slits, pores, etc., and preventing the flow of fluid or high pH solution.

The generation of hydrogen gas can be controlled so hydrogen is produced as needed. Control can be based on one or more criteria, such as: pressure (e.g., internal pressure or a differential between an internal and an external pressure); temperature (e.g., hydrogen generator, fuel cell or device temperature); a fuel cell electrical condition (e.g., voltage, current or power); or a device criterion (e.g., internal battery condition, power input, or operating mode. When hydrogen generation is no longer needed, a predetermined quality of high pH solution can be injected into the reaction area to stop the reaction.

The hydrogen generator system can use a variety of reactants that can react to produce hydrogen gas. Examples include chemical hydrides, alkali metal silicides, metal/silica gels, water, alcohols, dilute acids and organic fuels (e.g., N-ethylcarbazole and perhydrofluorene). At least one reactant is included in the fluid stored in the reactant storage area. The fluid can be a reactant or can contain a reactant (e.g., dissolved, dispersed or suspended therein).

As used herein, the term “chemical hydride” is broadly intended to be any hydride capable of reacting with a liquid to produce hydrogen. Examples of chemical hydrides that are suitable for use in the hydrogen generating apparatus described herein include, but are not limited to, hydrides of elements of Groups 1-4 (International Union of Pure and Applied Chemistry (IUPAC) designation) of the Periodic Table and mixtures thereof, such as alkaline or alkali metal hydrides, or mixtures thereof. Specific examples of chemical hydrides include lithium hydride, lithium aluminum hydride, lithium borohydride, sodium hydride, sodium borohydride, potassium hydride, potassium borohydride, magnesium hydride, calcium hydride, and salts and/or derivatives thereof. In an embodiment, a chemical hydride such as sodium borohydride can react with water to produce hydrogen gas and a byproduct such as a borate. This can be in the presence of a catalyst, heat, a dilute acid or a combination thereof.

Chemical hydrides can react with water to produce hydrogen gas and oxides, hydroxides and/or hydrates as byproducts. The hydrolysis reaction may require a catalyst or some other means of initiation, such as a pH adjustment or heating. Chemical hydrides that are soluble in water can be included in the liquid reactant composition, particularly at alkaline pH to make the liquid sufficiently stable. The reaction can be initiated by contacting the chemical hydride solution with a catalyst, lowering the pH (e.g., with an acid), and/or heating. Chemical hydrides can be stored as a solid, and water can be added. A catalyst or acid can be included in the solid or liquid composition.

An alkali metal silicide is the product of mixing an alkali metal with silicon in an inert atmosphere and heating the resulting mixture to a temperature of below about 475° C., wherein the alkali metal silicide composition does not react with dry O₂. Such alkali metal silicides are described in US Patent Publication 2006/0002839. While any alkali metal, including sodium, potassium, cesium and rubidium may be used, it is preferred that the alkali metal used in the alkali metal silicide composition be either sodium or potassium. Metal silicides including a Group 2 metal (beryllium, magnesium, calcium, strontium, barium and radium) may also be suitable. In an embodiment, sodium silicide can react with water to produce hydrogen gas and sodium silicate, which is soluble in water.

A metal/silica gel includes a Group 1 metal/silica gel composition. The composition has one or more Group 1 metals or alloys absorbed into the silica gel pores. The Group 1 metals include sodium, potassium, rubidium, cesium and alloys of two or more Group 1 metals. The Group 1 metal/silica gel composition does not react with dry O₂. Such Group 1 metal/silica gel compositions are described in U.S. Pat. No. 7,410,567 B2 and can react rapidly with water to produce hydrogen gas. A Group 2 metal/silica gel composition, including one or more of the Group 2 metals (beryllium, magnesium, calcium, strontium, barium and radium) may also be suitable.

One or more catalysts can be used to catalyze the hydrogen producing reactions. Examples of suitable catalysts include transition metals from Groups 8 to 12 of the Periodic Table of the Elements, as well as other transition metals including scandium, titanium, vanadium, chromium and manganese. Metal salts, such as chlorides, oxides, nitrates and acetates can also be suitable catalysts.

The rate of hydrogen generation can be controlled in a variety of ways, such as controlling of the rate at which liquid is transported to the reaction area, adjusting the pH, and making temperature adjustments. The rate of hydrogen generation can be controlled to match the need for hydrogen gas. A control system can be used for this purpose, and the control system can be within or at least partially outside the hydrogen generator.

Additives can be used for various purposes. For example, additives can be included with a solid reactant as a binder to hold the solid material in a desired shape or as a lubricant to facilitate the process of forming the desired shape. Other additives can be included with a liquid or solid reactant composition to control pH, to provide stability during storage and periods of nonuse, and to control the rate of reaction for example. Such additives include but are not limited to acids (e.g., hydrochloric, nitric, acetic, sulfuric, citric, carbonic, malic, phosphoric and acetic acids or combinations thereof), or basic compounds. Additives such as alcohols and polyethylene glycol based compounds can be used to prevent freezing of the fluid. Additives such as surfactants or wetting agents can be used to control the liquid surface tension and reaction product viscosity to facilitate the flow of hydrogen gas and/or effluents. Additives such as porous fibers (e.g., polyvinyl alcohol and rayon) can help maintain the porosity of a solid reactant component and facilitate even distribution of the reactant containing fluid and/or the flow of hydrogen and effluents.

In one embodiment, water is a first reactant and a chemical hydride such as sodium borohydride (SBH) is a second reactant. The SBH can be a component of a liquid such as water. The SBH and water can react when they come in contact with a catalyst, acid or heat in the reaction area. The SBH can be dissolved in water, in the reaction area or as the fluid in the fluid storage area. A base can be included in the solution to slow the reaction between the SBH and the water and provide stability during storage. The reaction can be initiated by bringing the solution into contact with a catalyst or an acid, contained in the reaction area or the fluid in the reactant storage area, by heating or by a combination thereof. Alternatively, the SBH can be stored as a solid in the reaction area. It can be present as a powder or formed into a desired shape. If an increased rate of reaction between the SBH and the water is desired, a solid acid, such as malic acid, can be mixed with the solid SBH, or acid can be added to the water. Solid (e.g. powdered) SBH can be formed into a mass, such as a block, tablet or pellet, to reduce the amount of unreacted SBH contained in the effluent that exits the reaction area. As used below, “pellet” refers to a mass of any suitable shape or size into which a solid reactant and other ingredients are formed. The pellet should be shaped so that it will provide a large contact surface area between the solid and liquid reactants.

In an example, a mixture including about 50 to 65 weight percent SBH, about 30 to 40 weight percent malic acid and about 1 to 5 weight percent polyethylene glycol can be pressed into a pellet. Optionally, up to about 3 weight percent surfactant (anti-foaming agent), up to about 3 weight percent silica (anti-caking agent) and/or up to about 3 weight percent powder processing rheology aids can be included in a pellet. The density of the pellet can be adjusted, depending in part on the desired volume of hydrogen and the maximum rate at which hydrogen is to be produced. A high density is desired to produce a large amount of hydrogen from a given volume. On the other hand, if the pellet is too porous, unreacted SBH can more easily break away and be flushed from the reaction area as part of the effluent. One or more pellets of this solid reactant composition can be used in the hydrogen generator, depending on the desired volume of hydrogen to be produced by the hydrogen generator. The ratio of water to SBH in the hydrogen generator can be varied, based in part on the desired amount of hydrogen and the desired rate of hydrogen production. If the ratio is too low, the SBH utilization can be too low, and if the ratio is too high, the amount of hydrogen produced can be too low because there is insufficient volume available in the hydrogen generator for the amount of SBH that is needed. In another example, a fluid including water is moved from the reactant storage area to the reaction area to react with solid sodium borohydride (SBH). The fluid includes an acid such as malic acid to provide a low pH to produce hydrogen gas at a desirable rate.

When hydrogen gas is no longer demanded, a quantity of high pH solution from the solution storage area is injected into the reaction area to raise the pH to stop the reaction. This may occur when the need for electrical power is no longer demanded from a fuel cell battery. The high pH solution increases the pH within the reaction area to stop the reaction, thereby preventing unwanted or excessive generation of hydrogen gas when the demand for hydrogen gas no longer exists. As a result, the hydrogen generator will be less likely to be subjected to high pressure and the containment assembly may be manufactured with reduced pressure containment requirements. To restart the reaction, additional fluid may be injected into the reaction area to lower the pH and thereby restart the reaction to generate hydrogen gas.

The high pH solution is contained within a solution storage area within the container, according to one embodiment. The high pH solution may be transferred in a predetermined quantity from the storage area to the reaction area through a fluid passage by way of a pump. The pump may be located within the container, according to one embodiment, or may be located outside of the container. According to one embodiment, the pump may be a pump that is shared with pumping of the reactant-containing fluid. In this embodiment, a valve may be employed to control which of the fluid and the high pH solution is pumped via the pump through the fluid passage into the reaction area. The high pH solution may be pumped from the storage area to the outside of the container and back into the container to the fluid passage into the reaction area. The high pH solution may be contained within the container in one embodiment, or may be located outside of the container, according to other embodiments.

The high pH solution may include a solution of deionized water and sodium hydroxide, according to one embodiment. In an exemplary embodiment, the high pH solution is made up of about 15 weight percent sodium hydroxide and 85 weight percent deionized water. According to another embodiment, the high pH solution may include deionized water and potassium hydroxide. The reaction to generate hydrogen may be restarted when fluid containing water and malic acid is subsequently injected into the reaction area, which lowers the pH to a value such as 2 and allows for the generation of hydrogen. The high pH solution has a high pH value of 12 or greater. In one example, the high pH solution has a pH value of about 14. High pH refers to a pH value greater than 7.0 and sufficiently high to stop or substantially slow the reaction. When the high pH solution is injected into the reaction area, the pH of the mixed reactants may rise to within the range of 12-14 to quickly stop the hydrogen-generating reaction. The higher the pH of the reaction mixture, the quicker the reaction stops. Hence, the lower the pH of the reaction mixture, the faster the reaction occurs.

The hydrogen generator can use hydrolysis of a hydride and water at a low pH to generate the hydrogen gas and may be operated intermittently by stopping and starting the reaction which may result in the formation of an insulating crust of hydrated product that may tend to reduce the efficiency of the remaining fuel upon restarting of the reaction. The crust may block off water access to the remaining hydride and hinder the start up after periodic use. To dissolve and break through the crust of basic reaction product, acid may be injected, e.g., in a high concentration, upon restarting of the reaction. Thus, acid can be injected into the water stream that enters the fuel cell cartridge after a sufficient long period of shutdown to dissolve and breakup the crust and allow for the more efficient reaction of the hydride products. The acid may be applied through the same fluid path used to apply reactant-containing fluid, high pH solution, or a separate fluid injection path. The acid may be stored within the container in a separate compartment utilizing the same pump used to supply the fluid or high pH solution to the reaction area.

According to another embodiment, ultrasonic or other sound waves may be applied to the hydride to break the crust of reaction product to thereby enable water to access the fuel for sufficient start up and generation of hydrogen. The hydrogen generator may utilize a speaker that generates sound waves after a sufficiently long period of non-use and/or whenever a new or partially used hydrogen cartridge is placed in the system. The speaker and associated control circuitry can be placed in the hydrogen generator or could be placed within the electronic device being powered such that it does not add to the cost or complexity to the fuel cartridge. The control circuitry may apply sound waves to the fuel cell and thus to the hydrogen generator when needed based on software and/or triggered by a cartridge insertion or reinsertion. The frequency of the sound waves may be tailored to the effectiveness of breaking up the crust. According to one embodiment, supersonic frequencies may be employed. By employing audible sound waves, the audible sound may serve as a feature to let the user know that the cartridge was reinserted and was working properly. In one embodiment, the sound waves may be at a resonant frequency of the fuel cartridge mixer. The resonant frequency may be varied and found for the hydrogen generator cartridge or may be estimated by a manufacturer beforehand. The frequency may also be selected as a function of the state of charge of the cartridge which is used to estimate the weight of the fuel.

It may be desirable to provide for cooling of the hydrogen generator during use, since the hydrogen generation reactions can produce heat. The housing may be designed to provide coolant channels. In one embodiment standoff ribs can be provided on one or more external surfaces of the housing and/or interfacial surfaces with the fuel cell system or device in or on which the hydrogen generator is installed or mounted for use. In another embodiment the hydrogen generator can include an external jacket around the housing, with coolant channels between the housing and external jacket. Any suitable coolant can be used, such as water or air. The coolant can flow by convection or by other means such as pumping or blowing. Materials can be selected and/or structures, such as fins, can be added to the hydrogen generator to facilitate heat transfer.

It may also be desirable to provide means for heating the hydrogen generator, particularly at startup and/or during operation at low temperatures.

The hydrogen generator can include other components, such as control system components for controlling the rate of hydrogen generation (e.g., pressure and temperature monitoring components, valves, timers, etc.), safety components such as pressure relief vents, thermal management components, electronic components, and so on. Some components used in the operation of the hydrogen generator can be located externally rather than being part of the hydrogen generator itself, making more space available within the hydrogen generator and reducing the cost by allowing the same components to be reused even though the hydrogen generator is replaced.

The hydrogen generator can be disposable or refillable. For a refillable hydrogen generator, reactant filling ports can be included in the housing, or fresh reactants can be loaded by opening the housing and replacing containers of reactants. In addition, a high pH solution filling port can be included in the housing or fresh high pH solution can be loaded by opening the housing and replacing the container of high pH solution. If an external pump is used to pump fluid reactant composition from the reaction storage area to the reactant area, an external connection that functions as a fluid reactant composition outlet to the pump can also be used to refill the hydrogen generator with fresh fluid reactant composition. Likewise, an external connection that functions as a high pH solution outlet to the pump can also be used to refill the hydrogen generator with fresh high pH solution. Filling ports can also be advantageous when assembling a new hydrogen generator, whether it is disposable or refillable. If the hydrogen generator is disposable, it can be advantageous to dispose of components with life expectancies greater than that of the hydrogen generator externally, such as in the fuel cell system or an electrical appliance, especially when those components are expensive.

The reactant storage area, reaction area, solution storage area and effluent storage area can be arranged in many different ways, as long as effluent storage area is in a volume exchanging relationship with one or more of the reactant storage, solution storage and reaction areas that will allow the initially compressed filter to expand as the effluent storage area increases in volume. Other considerations in selecting an arrangement include thermal management (adequate heat for the desired reaction rate and dissipation of heat generated by the reactions), the desired locations of external connections (e.g., for hydrogen gas, fluid reactant flow to and from an external pump), any necessary electrical connections (e.g., for pressure and temperature monitoring and control of fluid reactant flow rate), and ease of assembly.

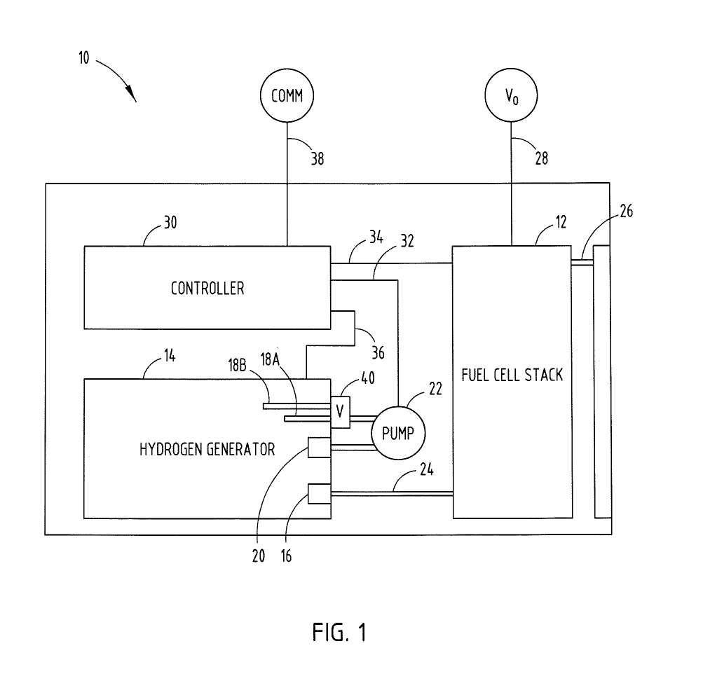

Referring to FIG. 1, a fuel cell system 10 is illustrated containing a hydrogen generator 14 which has high pH solution that is transferable to the reaction area to raise the pH of the reactants to quickly stop or substantially slow the generation of hydrogen, according to one embodiment. Fuel cell system 10 includes a fuel cell stack 12 and a removable hydrogen generator 14 for providing hydrogen gas fuel to the fuel cell stack 12. The hydrogen passes through an outlet valve 16 in the hydrogen generator 14, and through an inlet 24 to the fuel cell stack 12, where it is used as a fuel by the anode. Another gas, such as oxygen, enters the stack 12 through an inlet 26, where it is used as oxidant by the cathode. The fuel cell stack 12 produces electricity shown as voltage V_{O} that is provided to an electric device through a power output 28. Reactants within the hydrogen generator 14 react to produce the hydrogen. A fluid in the hydrogen generator 14 is transferred from a reservoir to a reactant area where the hydrogen is generated. The fluid is transferred by a pump 22, which can be disposed within or outside the housing of hydrogen generator 14. If the pump 22 is within the housing of the hydrogen generator 14, fewer external connections are needed, but if the pump 22 is an external pump, it can continue to be used after the used hydrogen generator 14 is replaced. In the embodiment shown, the pump 22 is shown outside the hydrogen generator 14. The fluid can be pumped out of the hydrogen generator 14 through an outlet valve 40 and back into the hydrogen generator 14 through an inlet valve 20. The fluid can be either a reactant-containing fluid received via fluid outlet passage 18B for producing hydrogen within the hydrogen generator 14 or a high pH solution received via fluid outlet passage 18A for stopping the hydrogen generation within the hydrogen generator 14. Outlet valve 40 may be controlled to select which of the reactant-containing fluid and high pH solution via passage 18A is pumped into the hydrogen generator 14 at a given time.

The fuel cell system 10 can include an optional control system for controlling the operation of the gas generator 14 and/or the fuel cell stack 12. Components of the control system can be disposed in the hydrogen generator 14, the fuel cell stack 12, the apparatus powered by the fuel cell system, or a combination thereof. The control system can include a controller 30. Although the controller 30 can be located within the fuel cell system 10 as shown, it can be located elsewhere in the fuel cell system 10 or within the electric device for example. The controller 30 can communicate through a communication line 32 with the pump 22, through a communication line 34 with the fuel cell stack 12, through a communication line 36 with the hydrogen generator 14 and valve 40, and through a communication line 38 with the electric device. Sensors for monitoring voltage, current, temperature, pressure and other parameters can be disposed in or in communication with those components so gas generation can be controlled based on those parameters.

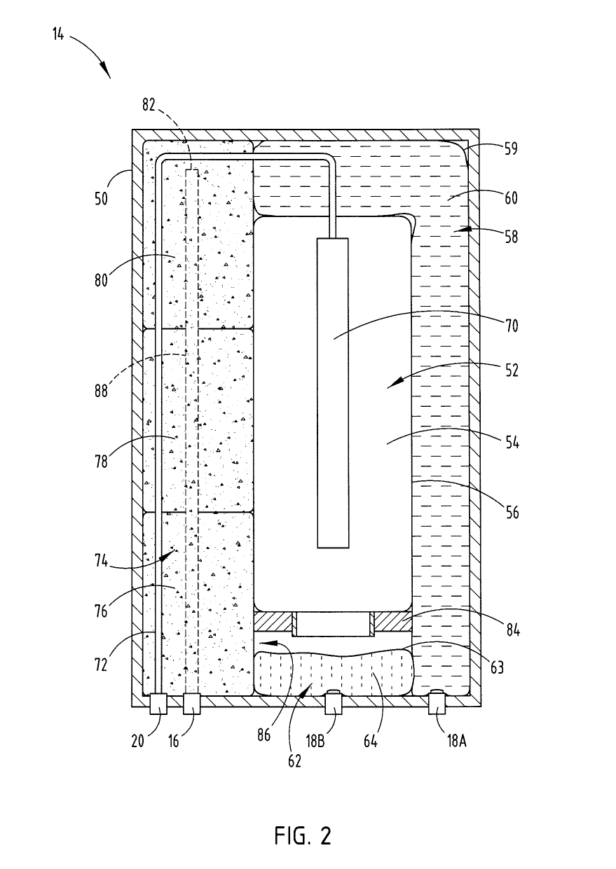

The hydrogen generator 14, according to one embodiment, is described below with reference to FIG. 2. The hydrogen generator 14 includes a reactant storage area 58, a reaction area 52 and an effluent storage area 74 within a housing 50. A first reactant composition 60 is contained within the reactant storage area 58, and a second reactant composition 54 is contained within the reaction area 52. The first reactant composition 60 is a fluid in the form of a liquid such as a water and acid solution that can be transported to the reaction area 52. The second reactant composition 54 can be a fluid or, as shown in FIG. 2, it can be a solid in the form of one or more pellets. The effluent storage area 74 includes a filter, which can have one or more filter components, such as three filter components 76, 78 and 80. The reactant storage area 58 is enclosed by an enclosure 59 such as a liquid impermeable bag. The hydrogen generator 14 further includes a solution storage area 62 containing a high pH solution enclosed by an enclosure 63 such as a liquid impermeable bag.

The reaction area 52 can be at least partially enclosed by an optional enclosure 56. The effluent storage area 74 can be enclosed by an optional enclosure (not shown). Various types of enclosures can be used for the reactant storage area 58, the reaction area 52 and the effluent storage area 74. For example, an enclosure can include internal surfaces of the housing 50, other internal components of the hydrogen generator 14 and/or it can share a common wall or section with one or more other enclosures. All or portions of the enclosures can be flexible, rigid, stationary or moveable, preferably as long as the effluent storage area 74 is in a volume exchanging relationship with at least one of the reactant storage area 58 and the reaction area 52. As shown, the enclosures 59, 63 and 56 enclosing the reactant storage area 58, the solution storage area 62, and the reaction area 52, respectively, are flexible enclosures that can collapse as first reactant composition 60 exits the reaction storage area 58, high pH solution exits the solution storage area 62, and effluent exits the reaction area 52. Examples of flexible enclosures include bags, balloons and bellows. It can be advantageous for flexible enclosures to be elastic so they can be stretched when full and tend to contract back to their original size as the contents exit, thereby helping to expel fluids as the hydrogen generator 14 is operated.

During use of the hydrogen generator 14, first reactant composition 60 is transported from the reactant storage area 58 to the reaction area 52 by any suitable means, as described above. For example, the first reactant composition 60 can be transported through a fluid outlet passage 18A. If a pump is used, the pump 22 can be within the housing 50, or it can be located externally as in the embodiment shown in FIG. 1. When a pump 22 is used, the first reactant composition 60 can be pumped through the fluid outlet passage 18A, such as a fluid outlet connection to the pump. Optional features, such as valves, filters and the like can be incorporated into the fluid outlet connection 18A. An external pump 22 can pump the first reactant composition 60 back into the hydrogen generator 14 through a fluid inlet connection 20. The first reactant composition 60 can flow to the reactant area 52 through a fluid inlet passage 72, such as a tube. Optional features such as valves, filters and the like can be incorporated into the fluid inlet connection 20. The first reactant composition 60 can exit the fluid inlet passage 72 directly from an opening in the end of the fluid inlet passage 72 or be delivered though a dispersing member 70 to disperse the first reactant composition over a larger portion of the reaction area 52. The dispersing member 70 can include one or more structures that extend into the reaction area 52. The structures can be substantially linear, as shown in FIG. 2, or they can have other shapes, as described above.

When an internal or external pump 22 is used, it can be powered at least initially by an external power source, such as the fuel cell or another battery within a fuel cell system or an electrical appliance or device. If the pump 22 is within the container 50, connection can be made to an external power source through electrical contacts. Alternatively, a battery can be located within the container to at least start the pump 22.

The second reactant composition 54 can be a solid composition containing a second reactant that will react with the first reactant in the first reactant composition 60. The second reactant composition 54 can be in a convenient form such as a pellet containing the second reactant and any desired additives. An optional catalyst can be included in or downstream from the reaction area. For example, the catalyst can be on or part of the reaction area enclosure 56, dispersed in the second reactant composition 54, or carried into the reaction area as part of the first reactant composition 60.

As the first reactant composition 60 comes in contact with the second reactant composition 54, the first and second reactants react to produce hydrogen gas and byproducts. The hydrogen gas flows out of the reaction area 52 and through an effluent passage to an effluent entryway 86, where it enters the effluent storage area 74. The hydrogen gas carries with it effluent that includes byproducts as well as unreacted reactants and other constituents of the reactant compositions 54 and 60. Where a reaction area enclosure 56 is used, the effluent exits the reaction area 52 though an aperture in the enclosure 56. The opening in the reaction area enclosure 56 can include an effluent exit nozzle 84, which can help keep the aperture open. The effluent exit nozzle 84 can optionally include a screen to hold large pieces of the second reactant composition 54 in the reaction area 52 to improve utilization of the second reactant. The effluent passageway can be a structure such as a tube (not shown) extending between the effluent exit nozzle 84 and the effluent entryway 86, or it can be spaces that are present or develop between the effluent exit nozzle 84 and the effluent entry 86, as shown in FIG. 2. Although it is desirable for the majority of the reactants to react within the reaction area 52, unreacted reactants in the effluent can continue to react after exiting the reaction area 52. An optional secondary reaction area (not shown) can be included between the primary reaction area 52 and the effluent storage area 74. Fresh first reactant composition 60 can be transported directly to this secondary reaction area, such as through a second fluid passage (not shown), to react with unreacted second reactant in the effluent from the primary reaction area 52. A catalyst can be disposed within the secondary reaction area.

Hydrogen gas and effluent entering a proximal portion of the effluent storage area 74 through the effluent entryway 86 flows through the filter 76, 78 and 80 toward a distal portion of the effluent storage area 74. As the hydrogen gas and effluent flow through the filter 76, 78 and 80, hydrogen gas is separated from solid particles of the effluent by the filter 76, 78 and 80, which can be a single filter component or multiple filter components, such as the three filter components 76, 78 and 80. As described above, the filter 76, 78 and 80 can have portions and/or filter components of different porosities, preferably increasing in porosity from the proximal portion toward the distal portion of the effluent storage area 74, where the hydrogen gas exits the effluent storage area 74.

The hydrogen gas may be separated from liquids and any remaining solids in the effluent before exiting the hydrogen generator 14 by a hydrogen permeable, liquid impermeable material. The hydrogen gas can exit the hydrogen generator 14 through a hydrogen outlet connection 16. The hydrogen outlet connection 16 can be located near the distal portion of the effluent storage area 74 as shown in FIG. 2, or it can be located elsewhere, such as near the proximal portion of the effluent storage area 74. If the hydrogen outlet connection 16 is not near the distal portion of the effluent storage area 74, the hydrogen gas can flow from the distal portion of the effluent storage area 74 to the hydrogen outlet connection 16 through a hydrogen outlet passage 88, such as a tube, which has a proximal end near the hydrogen outlet connection and a distal end 82 near the distal portion of the effluent storage area 74. The hydrogen gas can enter the hydrogen outlet passage 88 through the distal end 82. The hydrogen permeable, liquid impermeable material can be a component, such as a membrane, plug or filter element, preferably located at or near the distal end 82, or at least a portion of the hydrogen passage 88 can be made of a material that has high hydrogen permeability and low or no liquid permeability. If only a portion of the hydrogen passage 88 is made from a material with high hydrogen, low liquid permeability, that portion is preferably a distal portion to minimize the amount of solids in the effluent that comes in contact with and could clog the material, preventing hydrogen gas from exiting the effluent storage area 74.

If the hydrogen outlet connection 16 is located near the distal portion of the effluent storage area 74, the hydrogen generator 14 can include an optional compartment positioned between the hydrogen outlet connection 16 and the hydrogen permeable, liquid impermeable material. Alternatively, at least a portion of an effluent storage area enclosure (e.g., a flexible bag) near the distal portion of the effluent storage area 78 can be the hydrogen permeable and liquid impermeable material.

Hydrogen gas will be generated when the first reactant composition 60 reacts with the second reactant composition 54, provided the slurry of mixed reactants have a pH that is sufficiently low. When electrical power is no longer demanded and hence hydrogen gas is no longer required to be generated, the hydrogen generator 14 injects a predetermined quantity of high pH solution 64 into the reaction area 52 so as stop or at least significantly curtail the reaction. This advantageously prevents excessive generation of hydrogen gas that quickly stopping the reaction and allows for components of the hydrogen generator to be manufactured with reduced pressure and leakage requirements.

The injection of the high pH solution 64 into the reaction area 52 may be achieved by transporting a predetermined quantity of the high pH solution from solution storage area 62 out through fluid outlet passage 18B via pump 22. The predetermined quantity of high pH solution 64 may then be pumped into the fluid inlet connection 20 and injected via fluid inlet passage 72 and dispersing member 70 into the reaction area 52 to increase the pH of the reactants within the reaction area 52 and thereby stop the generation of hydrogen. The predetermined quantity of high pH solution 64 will depend upon the pH level, the size of the reaction area and the amount and type of reactants. The predetermined quantity of high pH solution may be determined based upon the resultant pH of the reactants needed for achieving the desired stoppage of the reaction. The pH level of the high pH solution 64 may be in the range of 12-14 when utilizing a basic solution of 85 weight percent deionized water and 15 weight percent sodium hydroxide, according to one embodiment. According to another embodiment, potassium hydroxide may be used in place of the sodium hydroxide. The high pH solution raises the pH of the mixed reactants in the reaction area to a pH of about 12-14 to quickly stop the hydrogen generation. While the high pH solution 64 is shown stored within the hydrogen generator 14 and is pumped via a pump external the hydrogen generator 14, according to one embodiment, it should be appreciated that the high pH solution 64 may be located outside of the hydrogen generator and may be otherwise injected into the reaction area 52.

In the embodiment shown, the first reactant composition 60 and the high pH solution 64 are transferred to the reaction area using a shared pump 32, shared fluid inlet connection 20, shared fluid inlet passage 72, and shared dispersing member 70. However, it should be appreciated that the first reactant composition 60 and the high pH solution 64 may be transferred to the reaction area via separate fluid paths, such as separate tubes and separate dispersing members, according to other embodiments. Additionally, a high pH solution could otherwise be injected into the reaction area, such as with a sliding door that is timed and controlled by a solenoid.

As shown, the effluent storage area 74 can be in a volume exchanging relationship with both the reactant storage area 58, the solution storage area 62, and the reaction area 52. As the hydrogen generator 14 is used, reactant composition 60 is transported from the first reactant storage area 58, which becomes smaller, to the reactant area 52, where first and second reactants are consumed as they react to produce hydrogen and byproducts. The hydrogen gas and effluents exit the reaction area 52, which becomes smaller, and enter the effluent storage area 74, which is able to become larger by gaining at least a portion of the quantity of volume lost by the reactant storage area 58, the solution storage area 62, and the reaction area 52. As the effluent storage area 74 becomes larger, the filter or at least one filter component 76, 78 and 80 expands to partially or completely fill the enlarged volume and accommodate the hydrogen gas and effluent. The relative sizes, shapes and locations of the areas 52, 58 and 74 can be varied as described above, as can passageways, connections and the like, as long as the effluent storage area 74 is in a volume exchanging relationship with at least one and preferably all of the reactant storage area 58, the solution storage area 62, and the reaction area 52, and the filter 76, 78 and 80 is initially compressed and expands during operation of the hydrogen generator as the volume of the effluent storage area 74 increases. The locations of other components, such as filter components, fluid connections, passageways, dispersing members, nozzles and the like can also be varied, whether the areas 52, 58, 74 are in the arrangement shown or in another arrangement.

The hydrogen generator 14 can include an optional moveable partition (not shown), between the effluent storage area 74 and adjacent portions of the reactant storage area 58, the solution storage area 62, and the reaction area 52, with the moveable partition able to move toward the reactant storage area 58, the solution storage area 62, and the reaction area 52 as those areas 52, 58 and 62 become smaller and the effluent storage area 74 becomes larger during operation of the hydrogen generator 14, as long as there is an effluent entryway 86 through which effluent can pass into the effluent storage area 74. Such a moveable partition can be used to facilitate compression of the filter components during assembly of the hydrogen generator 14. The hydrogen generator 14 can include other components not shown, as described above.

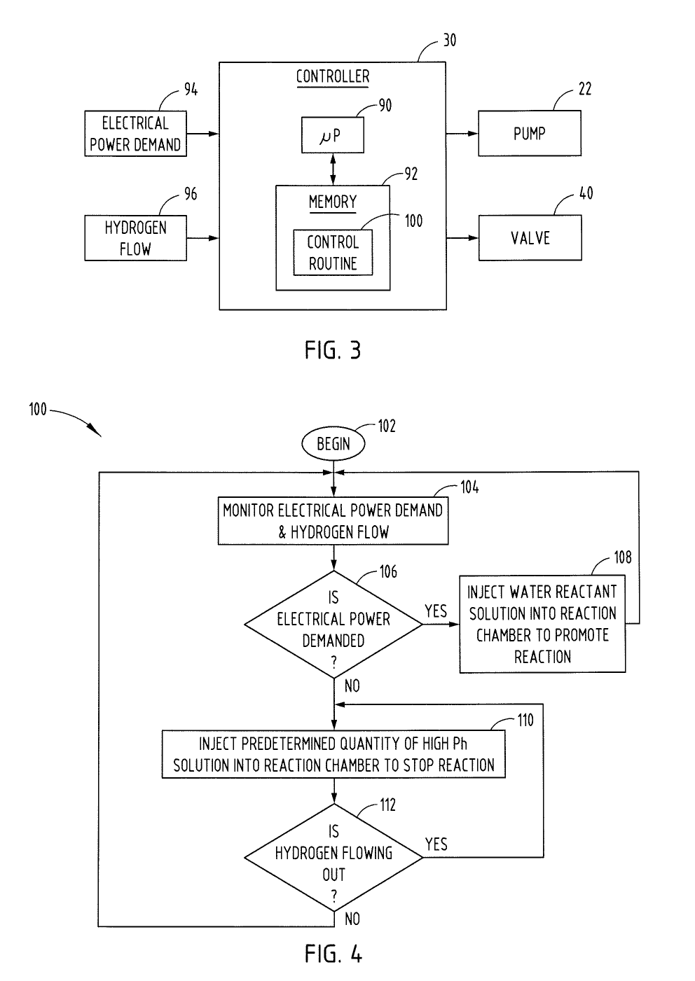

Referring to FIG. 3, a control system is illustrated for controlling the generation of hydrogen with the hydrogen generator. The control system includes a controller 30 which may include a microprocessor 90 and memory 92. It should be appreciated that other control circuitry may be employed, according to other embodiments. The controller 30 receives various inputs including an electrical power demand signal 94 and a hydrogen flow signal 96. The electrical power demand 94 may include one or more signals indicative of the demand for electrical power such as whether the electric device being powered is in the “off” state or “on” state. The hydrogen flow signal 96 provides the sensed indication as to the amount of hydrogen flowing out of the hydrogen outlet connection. The controller 30 processes the electrical demand signal 94 and hydrogen flow signal 96 and controls one or more devices such as the pump 22 and valve 40 to control the injection of the first reactant into the reaction area to generate hydrogen and the injection of high pH solution into the reaction area to stop the reaction.

Referring to FIG. 4, a routine 100 is illustrated which may be stored in memory 92 and processed by microprocessor 90. Routine 100 begins at step 102 and proceeds to step 104 to monitor the electrical power demand and hydrogen flow. Next, at decision step 106, method 100 determines whether electrical power is demanded and, if so, injects reactant solution containing water and acid into the reaction chamber to promote the reaction with one or more other reactants to generate hydrogen gas. If electrical power is not demanded, method 100 determines if hydrogen is flowing out of the hydrogen generator and, if so, method 100 proceeds to step 110 to inject a predetermined quantity of high pH solution into the reaction chamber to substantially reduce or stop the reaction and thus stop the generation of hydrogen. If hydrogen is not flowing out of the hydrogen generator, method 100 returns to step 104. Accordingly, the control system may execute the control routine 100 to control the generation of hydrogen and to stop the generation of hydrogen when electrical power is not demand. When electrical power is demand, such as when the electrical device is turned back on, method 100 will inject liquid reactant solution into the reaction chamber to promote the reaction which will essentially lower the pH of the reactants and restart the generation of hydrogen gas. As such, hydrogen may be stopped quickly to prevent the excess generation of hydrogen and pressure associated therewith, and may be restarted simply by continuing to inject further reactant.

A variety of materials are suitable for use in a hydrogen generator, including those disclosed above. Materials selected should be resistant to attack by other components with which they may come in contact (such as reactant compositions, catalysts, effluent materials and hydrogen gas) as well as materials from the external environment. The materials and their important properties should also be stable over the expected temperature ranges during storage and use, and over the expected lifetime of the hydrogen generator.

Suitable materials for the housing and internal partitions can include metals, plastics, composites and others. Preferably the material is a rigid material that is able to tolerate expected internal pressures, such as a polycarbonate or a metal such as stainless steel or anodized aluminum. The housing can be a multi-component housing that is closed and sealed to securely hold the components of the hydrogen generator and prevent hydrogen gas from leaking therefrom. Various methods of closing and sealing can be used, including fasteners such as screws, rivets, etc., adhesives, hot melts, ultrasonic bonding, and combinations thereof.

Suitable materials for flexible enclosures can include polypropylene, polyethylene, polyethylene terephthalate and laminates with a layer of metal such as aluminum. If an elastic enclosure is desired, suitable materials include silicone and rubbers.

Suitable materials for tubing, etc., used to transport fluid reactant composition and effluents can include silicone, TYGON® and polytetrafluoroethylene.

Suitable materials for filters and filter components can include foam materials. A foam material can have an open cell structure (an open cell foam) or closed cell structure (a closed cell foam). Generally a major part of the foam filter will have an open cell structure. In some embodiments the filter component or a portion thereof can have a closed cell structure or a skin on one or more surfaces, depending on the desired porosity and permeability to solids, liquids and gases. The filter components can be made from elastomeric foams, preferable with a quick recovery (low compression set/high recovery). The elastomer may be a resilient cured, cross-linked or vulcanized elastomer, for example. Examples of suitable elastomeric materials include one or more of: a polyurethane elastomer, a polyethylene, a polychloroprene (neoprene), a polybutadiene, a chloro isobutylene isoprene, a chlorosulphonated polyethylene, an epichlorohydrin, an ethylene propylene, an ethylene propylene diene monomer, an ethylene vinyl acetate, a hydrogenated nitrile butadiene, a polyisoprene, an isoprene, an isoprene butylene, a butadiene acrylonitrile, a styrene butadiene, a fluoroelastomer, a silicone, and derivatives and combinations thereof.

Other materials that can be used for the filter components include reticulated materials such as reticulated polyesters (e.g., polyethylene terephthalate), polyethylene, polyurethane, polyimide, melamine, nylon, fiberglass, polyester wool and acrylic yarn. As disclosed above, the filter does not necessarily have to be made of a material that can expand by itself after being compressed if another means of expanding the filter is provided.

Suitable materials for a dispersing member can include a liquid impermeable material, such as tubular or other hollow components made from materials such as silicone rubber, TYGON® and polytetrafluoroethylene, polyvinylidene fluoride (PVDF) and fluorinated ethylene-propylene (FEP), with holes or slits formed therein; a liquid permeable member made from a material such as cotton, a nylon, an acrylic, a polyester, ePTFE, or a fitted glass that can allow the fluid reactant composition to pass through or that can wick the fluid reactant composition; or a combination, such as a hollow liquid impermeable material with holes or slits therein and wrapped in, surrounded by or coated with a material that can wick the fluid reactant composition.

All references cited herein are expressly incorporated herein by reference in their entireties. To the extent publications and patents or patent applications incorporated by reference contradict the disclosure contained in the present specification, the present specification is intended to supersede and/or take precedence over any such contradictory material.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

1. A method of producing hydrogen gas using a hydrogen generator, the hydrogen generator comprising a container and a reaction area within the container, the method comprising the steps of:
moving a fluid comprising a first reactant from a reactant storage area to the reaction area to react the reactant in the reaction area to produce hydrogen gas; and
injecting a quantity of high pH solution having a pH value above 7.0 into the reaction area to stop the reaction when hydrogen gas is not demanded.

2. The method of claim 1 further comprising the step of detecting electrical power demand, wherein the high pH solution is injected into the reaction area when electrical power is no longer demanded.

3. The method of claim 1, wherein the high pH solution has a pH value in the range of 12-14.

4. The method of claim 1, wherein the high pH solution comprises water and sodium hydroxide.

5. The method of claim 1, wherein the high pH solution comprises water and potassium hydroxide.

6. The method according to claim 4 or claim 5, wherein the high pH solution comprises about 85 weight percent water.

7. The method of claim 1, wherein the high pH solution is contained within a solution storage area within the container.

8. The method of claim 1, further comprising the step of using a pump to pump the high pH solution from the solution storage area through a fluid passage into the reaction area.

9. The method of claim 8, wherein the pump is located outside of the compartment, such that the high pH solution is pumped from the solution storage area, to the pump outside the container and back into the container to the fluid passage.

10. The method of claim 9, wherein the pump further pumps the reactant from the reactant storage area, to the pump outside of the container and back into the fluid passage.

11. The method of claim 1, wherein the reactant in the fluid is a first reactant and comprises water, and a second reactant comprises sodium borohydride.

12. The method of claim 11, wherein the first reactant further comprises an acid.

13. The method of claim 11, wherein the second reactant further comprises an acid.

14. The method of claim 1, wherein the reactant storage area is within the container.

15. A hydrogen generator comprising:
a container;
a reaction area within the container;
a fluid comprising a reactant; and
a high pH solution;
wherein the fluid comprising the reactant moves to the reaction area to react to produce hydrogen gas, and wherein the high pH solution is injected into the reaction area to stop the reaction when hydrogen is no longer demanded.

16. The hydrogen generator of claim 15, wherein the high pH solution is contained within a solution storage area in the container.

17. The hydrogen generator of claim 16, wherein the fluid is contained with a reactant storage area in the container.

18. The hydrogen generator according to any of claims 15-17, further comprising a pump for pumping the fluid into the reaction area and pumping the high pH solution into the reaction area.

19. The hydrogen generator of claim 18, wherein the pump is located outside of the container.

20. The hydrogen generator of claim 18 further comprising a valve controlled to selectively pump one of the fluid and the high pH solution to the reaction area.

21. The hydrogen generator of claim 15, wherein the fluid comprises water as a first reactant, and a second reactant comprises sodium borohydride (SBH) is disposed in the reaction area.

22. The hydrogen generator of claim 21, wherein the second reactant further comprises an acid.

23. The hydrogen generator of claim 21, wherein the fluid comprises an acid.

24. The hydrogen generator of claim 12 further comprising a filter disposed between the hydrogen outlet and the reaction area.

25. The hydrogen generator of claim 15, wherein the high pH solution has a pH value in the range of 12-14.

26. The method of claim 15, wherein the high pH solution comprises water and sodium hydroxide.

27. The method of claim 15, wherein the high pH solution comprises water and potassium hydroxide.

28. The method according to claim 26 or claim 27, wherein the high pH solution comprises about 85 weight percent water.

29. A fuel cell system comprising:
one or more fuel cells;
a hydrogen generator comprising a container, a first reactant, an optional second reactant and a reaction area;
a reactant storage area containing a fluid comprising the first reactant;
a solution storage area containing a high pH solution; and
a controller for controlling the injection of the fluid into the reaction area and the injection of the high pH solution, wherein a quantity of high pH solution is injected into the reaction area to stop the reaction.
